(19) United States
(12) Patent Application Publication
(10) Pub. No.: US 2006/0259438 A1
(43) Pub. Date: Nov. 16, 2006

(54) Secure multi function network for point of sale transactions

(76) Inventors: William M. Randle, Bexley, OH (US); Randall E. Orkis, Pataskala, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 11/298,121

(22) Filed: Dec. 9, 2005

Related U.S. Application Data
(63) Continuation-in-part of application No. 10/283,038, filed on Oct. 25, 2002.
(63) Continuation-in-part of application No. 10/459,694, filed on Jun. 11, 2003.
(63) Continuation-in-part of application No. 10/823,442, filed on Apr. 12, 2004.
(63) Continuation-in-part of application No. 10/846,114, filed on May 15, 2004.
(63) Continuation-in-part of application No. 10/967,991, filed on Oct. 19, 2004.
(63) Continuation-in-part of application No. 11/154,033, filed on Jun. 15, 2005.

(51) Int. Cl. G06Q 99/00

(52) U.S. Cl. 705/65; 705/67

(57) ABSTRACT

A system providing a wide range of secure payment services from one or more communities of providers over any physical network infrastructure wherein a transceiver is interconnected by an individual user with a variety of service providers, such as funds sources or other applications, at a point of sale through a secure shared multi-function service network interconnecting the transceiver, the sources or applications, and the point of sale; and a secure shared multi-function service network for managing the security of the interconnections between and among the transceiver, applications and point of sale.

### RELATED APPLICATIONS

This application is a continuation in part of our co-pending applications: Dialect Independent Multi-Dimensional Integrator Using a Normalized Language Platform and Secure Controlled Access, Ser. No. 10/283,038, filed on Oct. 25, 2002; Standardized Transmission and Exchange of Data With Security and Non-Repudiation Functions, Ser. No. 10/459,694 filed on Jun. 11, 2003; Quality Assured Secure and Coordinated Transmission of Separate Image and Data Records Representing a Transaction, Ser. No. 10/823,442, filed on Apr. 12, 2004; End to End Check Processing From Capture to Settlement With Security and Quality Assurance, Ser. No. 10/846,114, filed on May 15, 2004; Secure Service Network and User Gateway, Ser. No. 10/967,991, filed on Oct. 18, 2004; and Secure Service Network and User Gateway, Ser. No. 11/154,033, filed on Jun. 15, 2005. The above identified applications are incorporated by reference as if set out in full herein.

### BACKGROUND AND SUMMARY OF THE INVENTION

The above applications relate generally to integrating authentication and authorization functions in a transaction payment system across the board with a comprehensive embedded security administration function that supports multiple governance models. The solution includes switch and verification means, users, services and multiple layers of security for allowing user sign on, encryption, authentication, authorization, activity non repudiation, SLA management, consumption based billing, session access, transaction processing of data and image files with quality comparisons and security at all levels from capture to settlement, check processing. A quality assurance algorithm is included at every or any stage of processing from capture through settlement, and a secure service network with unique audit and point of origin identifiers administered by service gateways across a broad community of users is independent of the physical network transport provider.

The present invention fills a need in providing access to funds, and the processing of purchase and payment transactions integrating a wireless network transceiver, or in an embodiment, a personal cell phone with the above systems and a Secure Multi-function Service Network as an interface for wireless, mobile and secure transaction processing across any physical IP network independent of carrier transport.

### DESCRIPTION OF THE DRAWINGS

FIG. 1A shows the system of the invention in which a personal transceiver cell phone with an SSG operates in a secure GSSG administered network, allowing point of sale secure payments initiated by the transceiver, securely administered through GSSG administered SSG's at all network participant nodes with virtual secure network connections as described in our previous applications to debit/credit, payment, exchange, management and settlement functions at a merchant's commercial bank. A Multifunction Secure Service Network is provided where all activity on the network is isolated and discrete from all other traffic as defined by a service. This allows multiple payment types, products, services, applications, users, and functions to be run one the same physical network connection but maintains discrete isolation for security, privacy, billing, SLA, and compliance needs for all traffic. This also allows infinite functions to run in isolation across a converged network without changes to the underlying transport. The result is a secure multifunction network capability independent of carrier provider, or carrier type (wired or wireless) including the ability to traverse private and public networks including the Internet with absolute security, audit ability, and end to end compliance reporting.

FIG. 1B shows an alternate configuration of system interconnections showing the relationships between and among the user's retail interconnections and the merchants' network connections to the merchants' bank[s] whereby any retail payment type or transaction is captured, converted, monitored, securely managed, and settled.

FIG. 1C shows a further alternative in which a user of a cell phone transceiver initiates a POS transaction accessing a checking account, and biometric identification and authorization security measures are implemented through media interconnected with the user's cell phone. All network transactions are discrete, isolated, and specific to the participants of the transaction as defined by a service (which can be an application, web service or business function on a traditional network) on the SSN or SMFSN network of the invention.

FIG. 2A and FIG. 2B schematically depict the secure network administration with which the system of the invention is used. The Secure Services Network (SSN) is network software or hardware that creates and manages a Virtual Secure Service network topology on any mix of physical networks. In this manner the SSN secures the exchange of digital information between parties in a trusted, reliable, and manageable manner across any network or combination or network elements. In addition all devices, application or web services running on the network inherit a based security model that allows for the creation of a secure multifunction network over a shared physical network connection. In a typical SSN, global secure service gateways (GSSG's) administer one to one, one to many, etc., network interconnections through administered secure service gateways (SSG's) at user's access points. All administration services enforce the same security for all SSN services assuring protection and privacy of all participants. Multiple governance models are supported as defined in our prior applications. The invention uniquely provides the ability to securely manage network service from a wide range of providers down to an individual device such as the cell phone. In this manner, the network facilitates the presentment and access to market communities from a wireless or portable payment device independent of the provider of the device. For example, the end user may select from a list of payment types and payment providers at the point of presentment, allowing the user to shop for the best payment and settlement mechanism from a wide range of providers to meet the needs of a given transaction. The functions described can all be accomplished over the same physical network connection while maintaining absolute security for each and every transaction type and service down to the specific transaction and service by provider. Additionally, the SSN allows merchants to provide multiple security functions and payment types to any endpoint on the network. In this manner, the merchants or merchant financial providers provide absolutely secured services.

FIG. 3 shows an example of real time monitoring available in the net settlement system optionally implemented at the site of a debit/credit/payment recording or collection facility. Real Time Net Settlement (NSS) is a settlement software, or hardware, solution that provides a real-time view of balances and payments exchanges between members of a community.

FIG. 4 shows the Payments Management Center (PMC), an enterprise payments repository, optionally implemented at the site of a debit/credit/payment recording, collection facility, or as a service on the network, that delivers a total view of payments and provides real time tracking of all payment and payments type across all LOBs or service providers.

FIG. 5 illustrates the functions of the Payments Exchange Network. The Payments Exchange (eP^{x}) is a payments exchange software solution that processes, clears, and routes all payments on a single, straight-through platform. This can be operated by a participant on the network as a service bureau or as a service on the network for other payment and payee providers allowing the creation of aggregated services by combining multiple services into an composite service while maintaining all of the elements of security previously identified.

FIG. 6 Illustrates the Log Record detail for a transaction on SSN. Specifically the information captured for each and every transaction is reflected. Request UID, Originator UID, and Correlation UID and, additional information such as elapsed time, date/time, response Code, participants, layer 3 mapping, and message sizes are tracked and captured for all traffic on SSN. The information is specific to a service and specific participants—which allows for privacy and end to end audit specific to the participants on SSN.

FIG. 7 illustrates a provisioning process window from the SSN management console for services on the network, reflecting the ability for a wide range of services, service types, service providers and service requesters to be provisioned and managed across any combination of physical networks.

### DESCRIPTION OF THE INVENTION

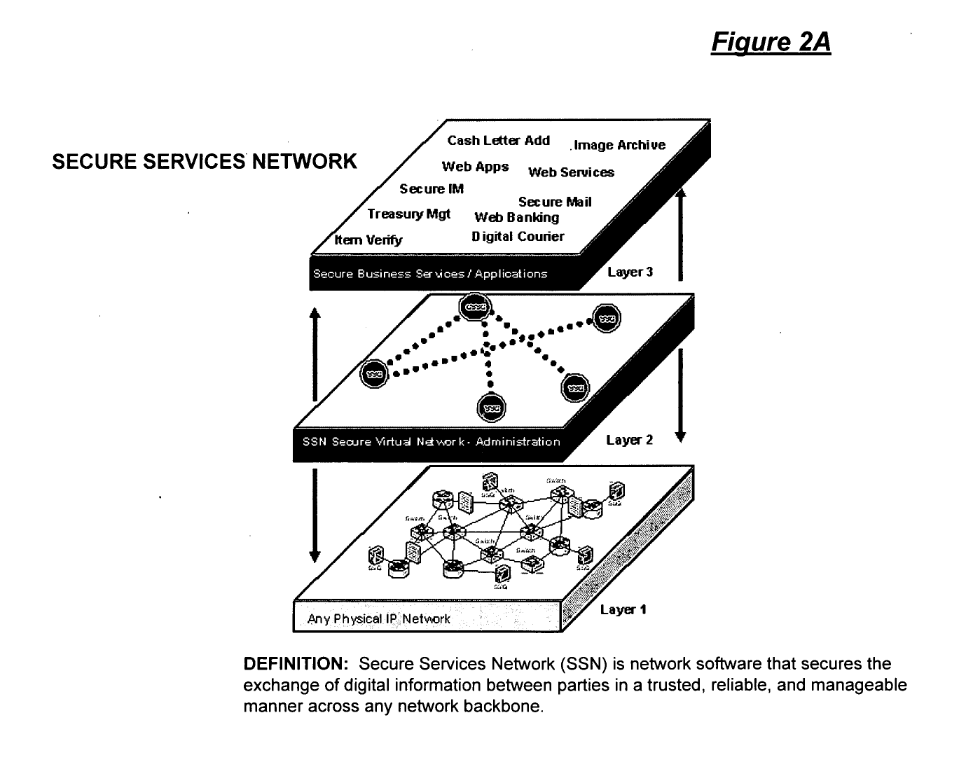

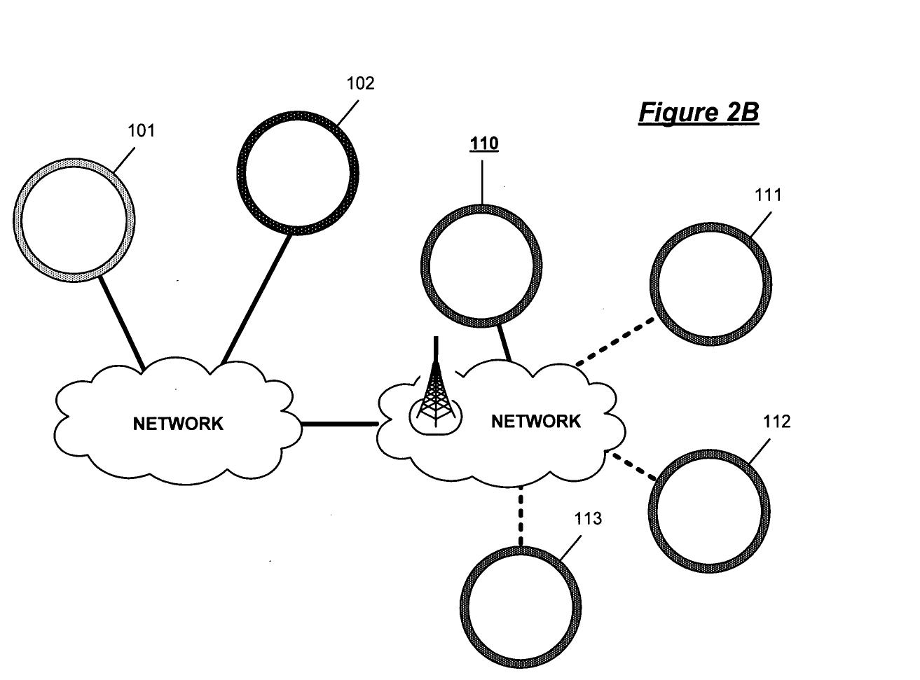

The invention provides functionality in a transceiver device such as a cell phone, smart phone, or other wireless network transceiver, to select, aggregate, initiate, process and effect secure transactions at a point of sale (POS) site. The transceiver is interconnected through a Secure Multi-Function Network (SMFSN) through secure service gateway (SSG) to a network managed by a global secure services gateway (GSSG) where a community of payment services is available to the device. The cell phone is equipped with an SSG; SSG's at the user sites are also administered by the GSSG for the network in which the phone user and merchant are members. For clarity in the drawing figures, the administration interconnections between the GSSG and the user sites, e.g., point of sale terminals, ATMs, transceiver users, etc., are not always shown, but are, however implied in the overall GSSG/SSG security protocol. Connectivity can be peer to peer or hub and spoke depending on the governance model implemented. See FIG. 2A. Mutual and multi-factor authentication is provided as a default function of the network with optional PKI certificates that also support service authorization. As an example of a payment service, the user of the device is identified as an account holder having a unique identifier, numerical address, phone number or equivalent. Additional security measures in the phone, such as a PIN, biometrics, secret phrase, digital certificate may be integrated in the system. The invention allows the availability of a wide range of secure payment services from one or more communities of providers over any physical network infrastructure wherein a transceiver is interconnected by an individual user with a variety of service providers (funds sources) at a point of sale through a secure shared multi-function service network (SSN) interconnecting the transceiver, a funds source associated with the transceiver and the point of sale, and an SSN implementation for managing the security of the interconnections between and among the transceiver, funds source and point of sale. From a user perspective, multiple transaction types over a secure multifunction service network using a transceiver system are effected. A cell phone, smart phone, or other transceiver capable of an interconnection effected by an individual user with a funds source at a point of sale initiates the transaction. A secure service network interconnects the transceiver, a funds source associated with the transceiver and the point of sale, and a global secure service gateway managing provisioning and service interconnections between and among the transceiver, funds source and point of sale. Authentication and authorization mechanisms are provided as a function of the service network to insure secure verification within the network of the user of the transceiver as the true user of the transceiver and the true owner of the funds source. The user can enter a debit or credit with respect to the point of sale from or to the funds source over the secure network. The network includes mutual authentication and multi-factor authentication as a function of any service or application attached to and effecting a connection over the network. Biometric user identification may be incorporated. The funds source may be interconnected with a payments network to allow debit, credit, payment and settlement of funds accessed by a user from the funds source which may be a cash account or a credit account.

In one example, a signal initiated by a button, touch screen, biometric reader, or combination, activates a Virtual Service Connection (VSC).; A PIN or other form of additional personal identification known only to the user may be required as a condition of log on (1) to the secure network and (2) to an interconnection over the secure network to a POS location to effect a transaction. The SSN shown in FIG. 2A and FIG. 2B is software (or hardware equivalent) that enables the creation of a Secure Shared Multi-Function Service Network and network community of services over any physical network infrastructure. SSN software (or hardware) Is comprised of secure gateways (SSG's) that are the on-ramps to the SSN and a network management facility (GSSG) that enables reporting, policy, compliance, billing, and privacy management across an SSN VSC topology. The combination of functions and the GSSG and SSG allows for implementations to support multiple governance models. SSN software works with web services (HTTP, SOAP, WSDL) using the WS-I specification, native HTTP applications (web browser applications), and legacy applications and protocols (through integration or tunneling). In addition SSN supports many additional protocols focused on network convergence and multi media services. These include SIP or IAX for VOIP, UDP, and many others defined under the traditional TCP standards for protocol support above layer 2 and 3 in a traditional OSI network model.

In the present invention, the SSN is adapted, in various configurations, to use the ubiquitous mobile cell phone to effect secure payment transactions at various points of sale. An example of a SSN implementation is illustrated in FIG. 2B. In the SSN shown in the example of FIG. 2B, members 101 and 102, each equipped with SSGs, are interconnected in a network 100, in a connection managed by GSSG 110. GSSG 110 in turn is interconnected with network service provider 111 to administer the one to one, or one to many, or many to many, secure network connections and to provide event analysis: logging analysis, event tracing, billing analysis, and SLA analysis. Processor administration station 112 provides topology management: service repository management, network organization management, service implementation management, access control list management, end user management, security proxy management, and access control list services. Service module 113 provides PKI and Certificate of Authentication management: as a third party to mediate PKI, sign security proxy requests, revoke certificates, and provide certificate revocation lists. Secure service network member 101, through the network accesses secure service network member 102, connecting through SSGs at both sides. An authentication service may be used on the network to facilitate a higher level of user authentication than what is provided by the base SSG or application connected to the network. In this manner, user authentication can be linked to credential repositories stored internal to a service provider on the network where access is controlled by the provider or an agent of the provider.

Member 101 provides a request for authentication, logging, and integration to enterprise systems available at member 102. In one governance model, the request is processed at GSSG 110 and the SSN components 111, 112 and 113 whereupon, upon receipt of access approval, member 102 reciprocally provides authentication service, local and/or central authorization, logging, and integration to enterprise systems allowing member 101 secure one to one access through the administered SSG's to the requested business service implementation. This may be accomplished for each and every service provider on the SSN such that a market community is available to the user of the POS and wireless device for real time payment decisions that include method selection and method validation. In the network, services provided may be singular to a provider or an aggregate combination of services by multiple providers over the SSN implementation. Elements of security necessary to effect and support a transaction or activity on the network from the transceiver are provided at a base level as a function of the network; and the base level elements of security on the network may include mutual authentication, authorization, payload encryption, transport independent encryption, privacy, end to end audit, and non-repudiation for compliance reporting. The payload for a transaction may be encrypted independent of the transport and the payment may be specific to the participants of the transaction; data stored is encrypted at rest and accessed only by one or more of participants to the transaction. A transaction UID that is unique to each transaction effected by the network is created and managed as a function of the network. In a variation, a correlation UID that is specific to a series of service events on the network establishes transitive trust as a function of the network and the ability to track and recreate the events of a muti-service transaction are captured and maintained in a file specific to the transaction to allow the reconstruction of the events associated with a transaction. End to end non-repudiation of a transaction is uniquely provided in the system. An origination UID can be populated by the transceiver, user, or application connected to the SSN such that end to end logging and transitive authentication can be supported, tracked and enforced; the UID is created and managed as a function of the network. Additional elements of security in support of either further authorization or further authentication on the network for a given service or function can be created and managed as a function of the network; examples are WS-S, SAML, XML certificates, OLDAP, Active Directory, LDAP, and other credential related means. The secure multifunction service network is provided as a web service; a web application can be accessed as the service used through the transceiver. The service definition on the network links between web services from one or more providers and applications from one or more providers on an implementation of the SSN to effect an aggregated service on the network.

Secure payment transactions are effected using a transceiver cell phone, smart phone, or other transceiver capable of an interconnection effected by an individual user with a funds source at a point of sale. A secure service network interconnects the transceiver, a funds source associated with the transceiver and the point of sale. A global secure service gateway manages the security of the interconnections between and among the transceiver, funds source and point of sale. Upon authentication and authorization, the user of the transceiver is securely verified as the true user of the transceiver and owner of the funds source. The user can enter a debit or credit with respect to the point of sale from or to the funds source over the secure network; in the SSN network, the user is verified as the true owner of a checking account. A biometric user identification may be adapted intrinsically in the transceiver. The user funds source, a retail bank, or credit card system, may be interconnected with a payments network that allows at least one of the debit, credit, payment and settlement of funds accessed by a user from the funds source. Thus, a multi function network for point of sale transactions is administered by a GSSG with access points securely maintained at local, individual SSGs. Using a cell phone, smart phone, or other transceiver capable of an interconnection, multiple transaction types over a secure multifunction service network using a transceiver system can be made. A payment originator (merchant) at a point of sale initiates the transaction with the user. The SSN interconnects the transceiver, a funds source associated with the transceiver and the point of sale, and a GSSG manages provisioning and service interconnections of SSGs between and among the transceiver, funds source and point of sale.

### EXAMPLE I

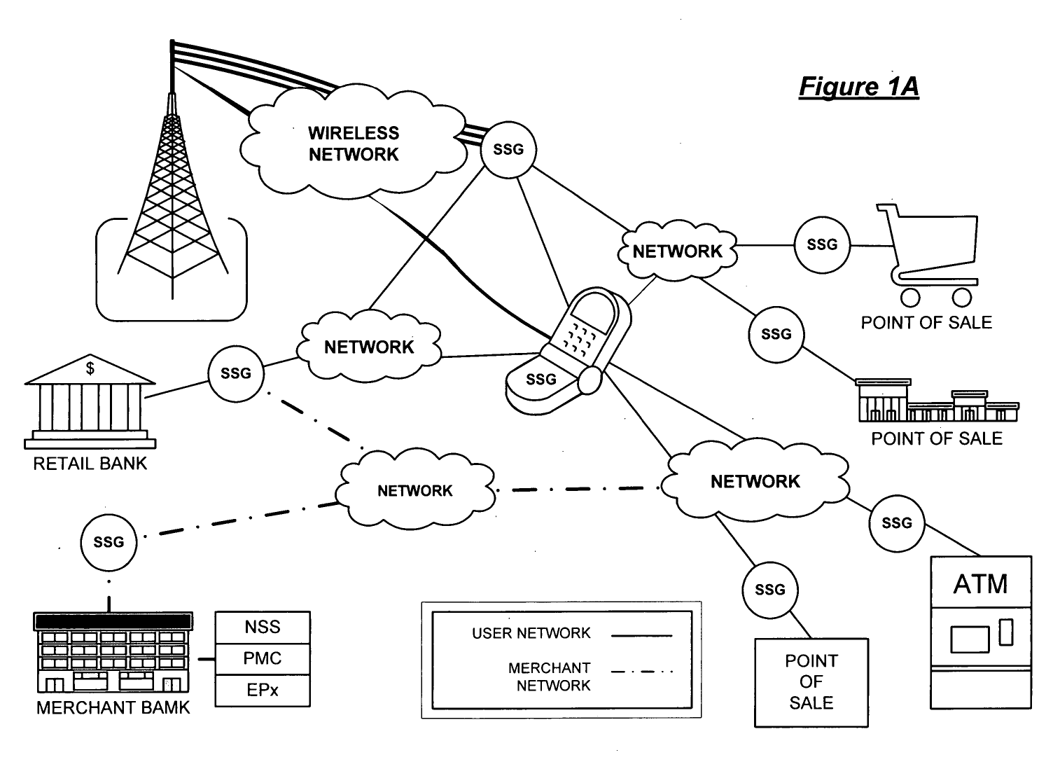

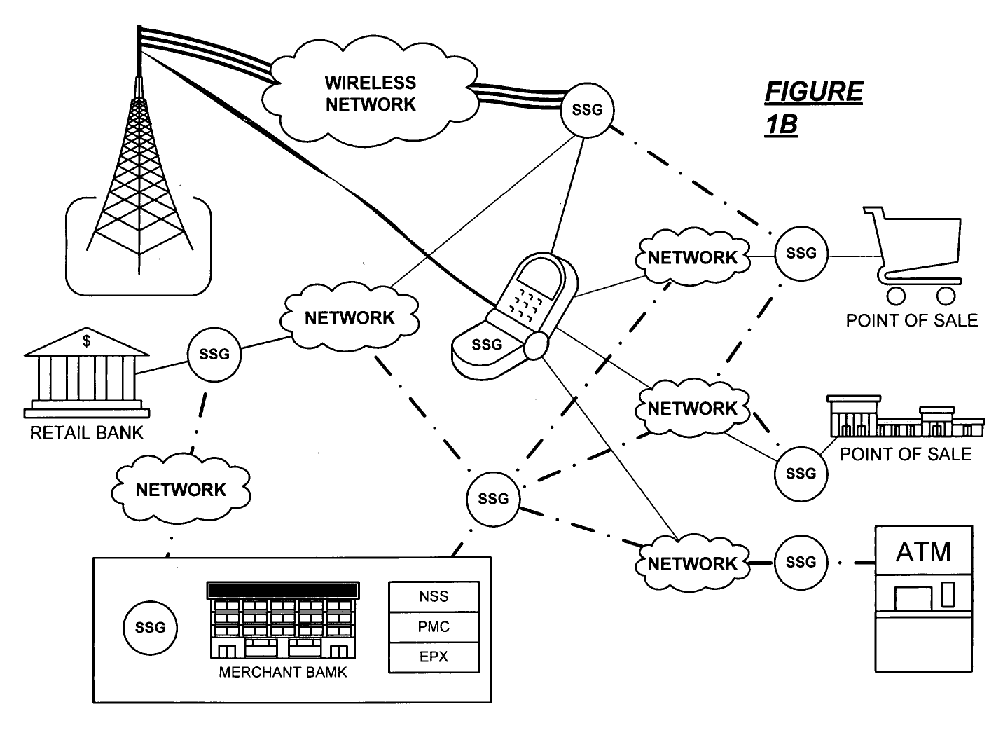

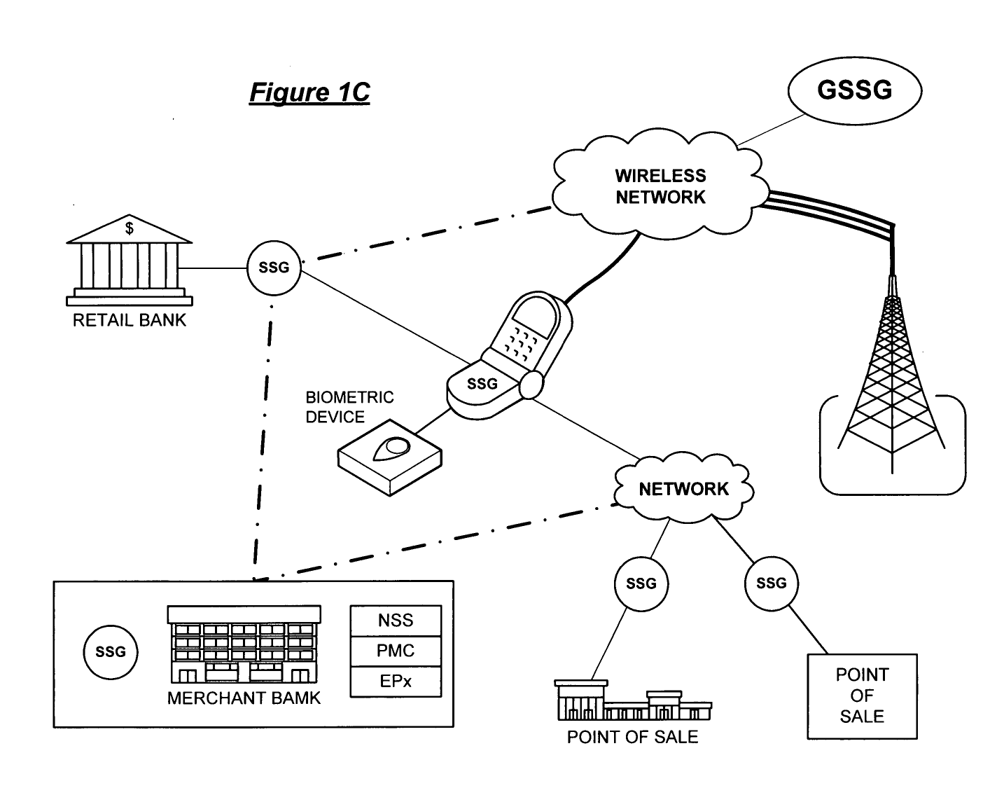

As shown in FIG. 1A and FIG. 1B, a wireless device, cell phone, smart phone, or equivalent transceiver medium capable of wireless network communications is shown. The transceiver unit is interconnectable with an integrated processor including a SSG capable of SSN receiving and storing information, and optionally providing tracking, accounting and other financial functions. Through an SSN network, which may be configured in many alternative interconnections managed by a Global Secure Service Gateway (GSSG), as shown in FIG. 2A and FIG. 2B (and described, inter alia, in the co-pending applications Ser. No. 10/967,991 and Ser. No. 11/154,033 in which I am co-inventor), the transceiver device may be loaded with a predetermined amount of currency from the customer's retail bank. An network interconnection between the cell phone and a point of sale, such as a grocery store, a mall merchant, an ATM, or other site (POS sites) allowing a monetary transaction is made through the transceiver to the POS through SSN over an SSN created VSC specific to that service and the participants of the transaction.

The SSG's at the POS sites and the cell phone assure that the merchant effects a secure connection to the customer's cell phone, and that through the SSN, the funds charged to the phone, or alternatively, through the cell phone physical network, in real time, to the cell phone user's bank ash or credit account (also members of the SSN and SSN service providers), can be debited to the merchant's account.

Alternatively, the secure interconnection of the phone, or other transceiver, allows real time transactions to be conducted without a reserve of user funds charged to the telephone. For example, a purchase can be made and the debit owing can be transmitted through the secure network to the cell phone holder's retail bank, where a cash or credit account may be debited in the amount of a purchase. Thereupon, the merchant's account at the merchant bank is credited with the purchase amount.

Utilizing the SSN, communications are secure, authentication is mutual and multi-factor, and authorization at the phone may be effected by entering a coded PIN number, known only to the account holder of the phone, in the phone keyboard or other human interface on the phone that is validated locally or externally as a service over SSN where the credential validation is a service on the network that may or may not be specific to the cell phone provider or service provider. As used herein, “point of sale” may be any interconnectable SSN site with the cell phone, wireless device, computer, self service terminal, vending machine, wherein funds may be debited or credited to the user's account, an account held by a participant on the SSN, or at an account held by a non-participant on the network where account access is accomplished out of band of an SSN implementation.

FIG. 1B shows an alternative interconnection of retail and merchant networks useful for processing checks in the system. In the drawing figures, it is evident that a user in the SSN may be interconnected in one or more GSSG administered networks. Users and POS providers may also be interconnected in one or more SNN's, for example, an SSN interconnecting a merchant bank with retail banks, a customer SSN interconnecting account holders with retail banks, an SSN merchant network, such as Visa®, and others are evident. As an alternative, separate SSN's may require separate SSGs administered by a GSSG for each network in which the participant is a member.

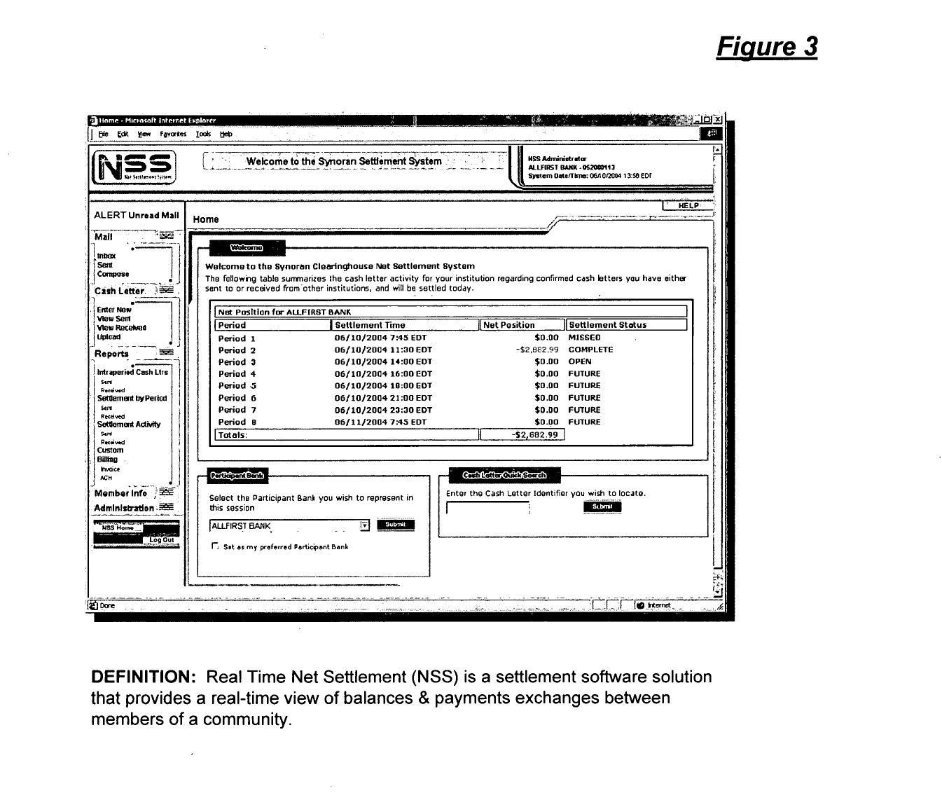

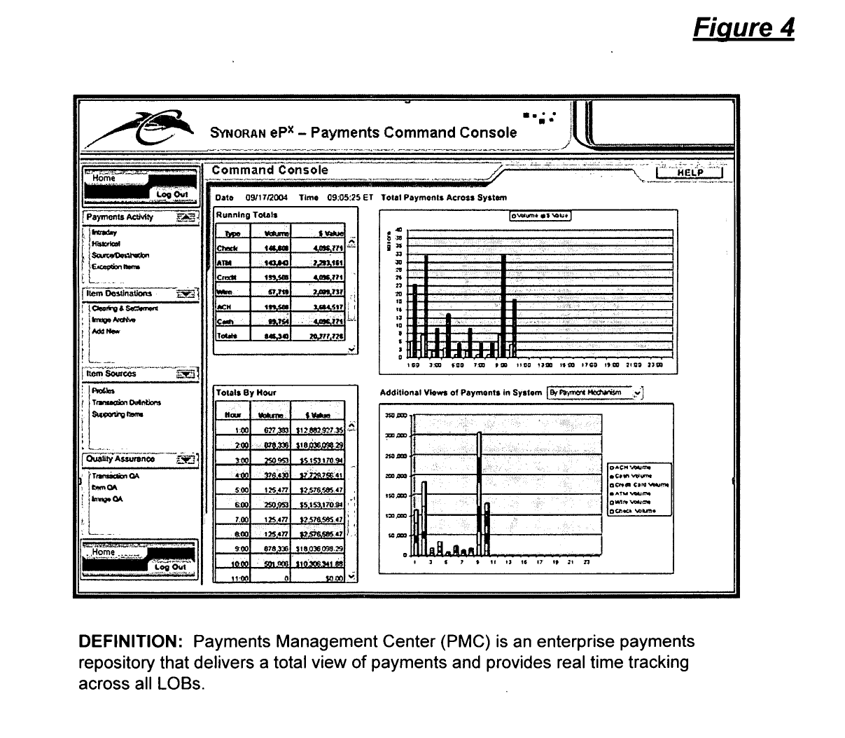

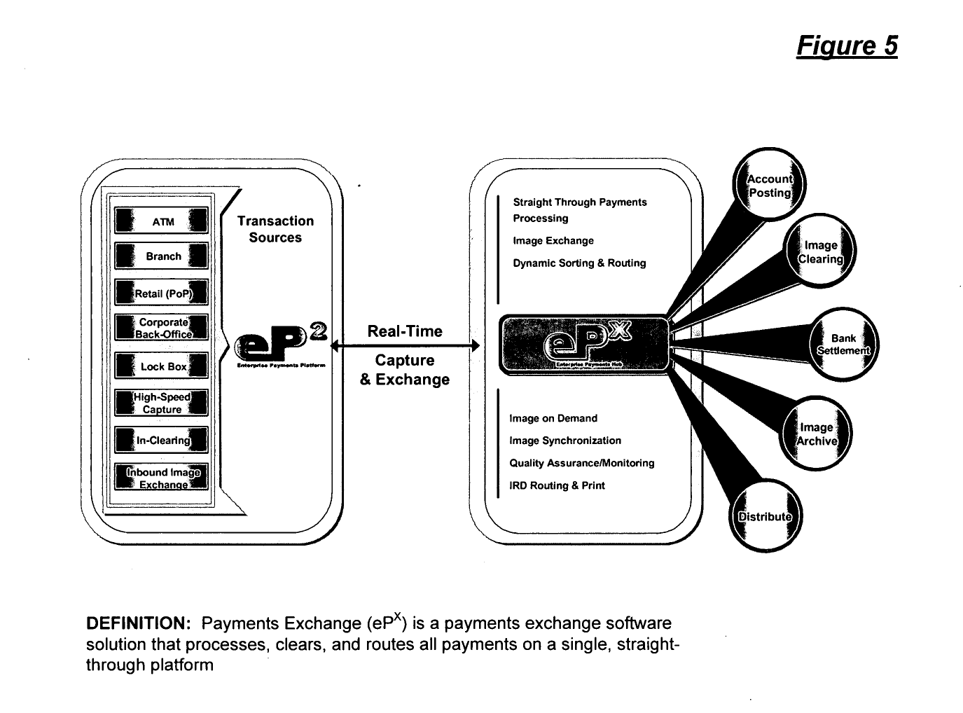

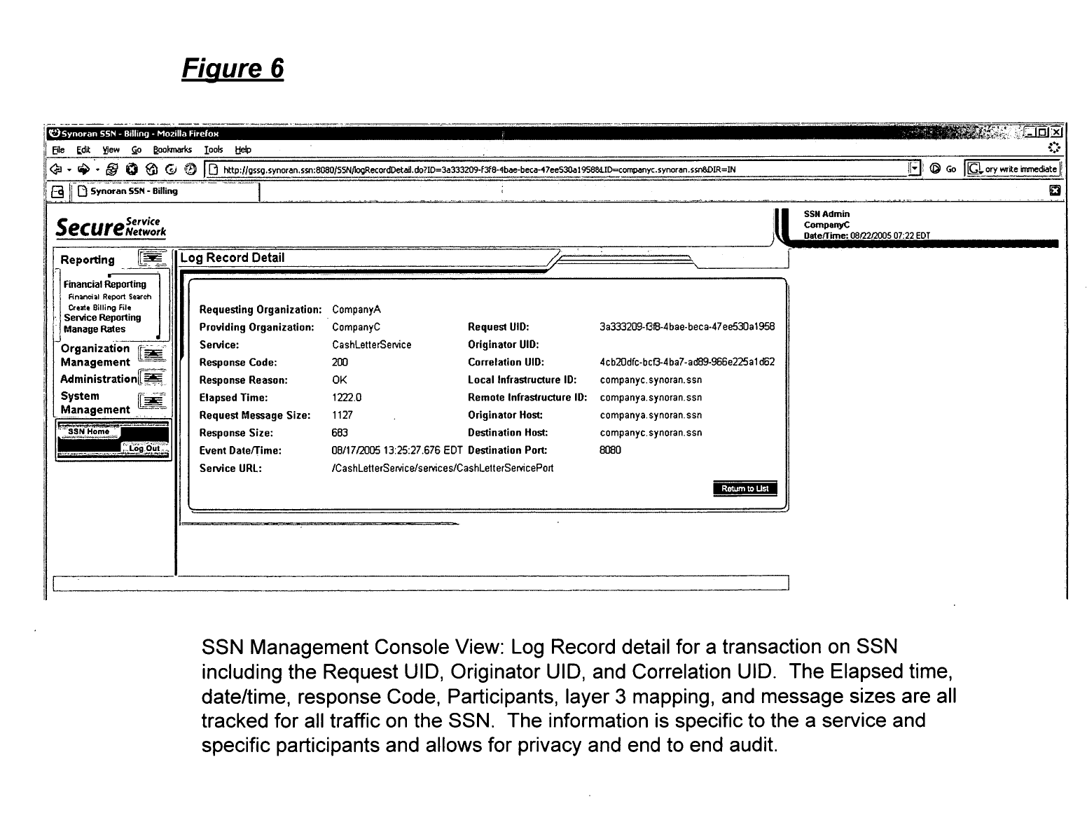

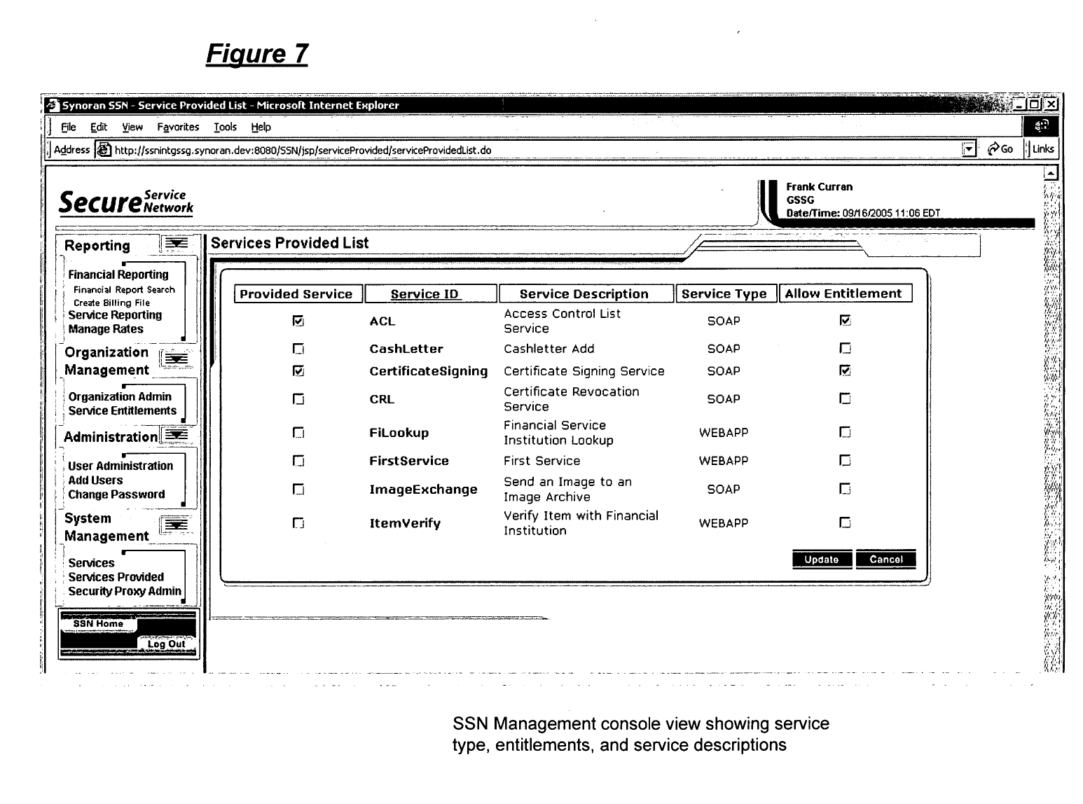

Upon processing the user debit or credit, the SSN may simultaneously interconnect with the merchant bank and the transaction is processed with respect to the merchant account through commercial bank facilities. Typical of such facilities are net settlement, payment management, and/or payment exchange systems accessed and implemented through a merchant bank network utilizing the NSS, PMC and eP^{x} systems as shown in FIG. 3, FIG. 4 and FIG. 5. These systems may also be provided as services on an SSN implementation where participants can access these service or aggregate these services to effect a transaction. NSS, PMC and eP^{x} are products of Synoran LLC, Columbus, Ohio; NSS, PMC and eP^{x} are, in part or in whole, described and claimed in the related applications listed above in which we are co-inventors.

### EXAMPLE II

In FIG 1B, the cellular network SSG is configured to interconnect directly with the cell phone user's retail bank. Additional SSN security measures may be implemented at the transceiver level, such as biometric voice, fingerprint and ocular reading, before a network connection is effected. Simultaneously with user activation, the merchant connects through the SSN network to the user and the merchant's bank, whereupon a transaction may be effected. Upon entry of a transaction, identifying the amount, payor, payee, payor's bank, payee's bank, transaction information is transmitted debiting the user's debit or credit account, and crediting the merchant's account. Processing the payment information through eP^{x}, PMC and/or NSS at the merchant bank allows real time monitoring and settlement on behalf of the bank associated with the user and the merchant, as well as the merchant's account at the merchant bank with regard to other banks and customers of the merchant. While ePx, PMC, and NSS are shown in the figure, applications with like functionality may be included in the implementation. In this manner, the participants are not required to use ePx, PMC, NSS to effect the transaction because SSN allows defining a service on the network that is independent of the application that my ultimately full fill that service. The service provider determines the processing flow for any service the provider offers on the network.

### EXAMPLE III

In FIG. 1C, security measures are implemented at the cell phone level, such as biometric voice, fingerprint and ocular reading, before a network connection is effected. As in preceding examples, upon user activation through the SSN network, the user connects to the merchant, the merchant connects to the user and to the merchant's bank, whereupon a transaction may be authorized and effected. In this example, identification and authorization is securely accomplished, logged, and verified in a checking account transaction, independently of a user's direct access to funds or debit facility at a user's bank.

Having thus described the invention in detail, those skilled in the art will appreciate that, given the present disclosure, modifications may be made to the invention without departing from the spirit of the inventive concept herein described. Therefore, it is not intended that the scope of the invention be limited to the specific and preferred embodiments illustrations as described. Rather, it is intended that the scope of the invention be determined by the appended claims.

What is claimed is:

1. A system for effecting multiple transaction types over a secure multifunction service network using a transceiver comprising:
a cell phone, smart phone, or other transceiver capable of an interconnection effected by an individual user with a funds source at a point of sale;
a secure service network interconnecting the transceiver, a funds source associated with the transceiver and the point of sale; and
a global secure service gateway managing provisioning and service interconnections between and among the transceiver, funds source and point of sale, and
authentication and authorization mechanisms as a function of the service network providing secure verification within the network of the user of the transceiver as the true user of the transceiver and the true owner of the funds source.

2. The system of claim 1 wherein the user can enter a debit or credit with respect to the point of sale from or to the funds source over the secure network.

3. The system of claim 1 wherein the user is verified as the true owner of a checking account as a function of the network wherein the network includes mutual authentication and multi-factor authentication as a function of any service or application attached to and effecting a connection over the network.

4. The system of claim 1 or claim 2 or claim 3 including biometric user identification.

5. The system of claim 1 or claim 2 or claim 3 or claim 4 wherein the funds source is interconnected with a payments network allowing at least one of the debit, credit, payment and settlement of funds accessed by a user from the funds source.

6. The system of claim 5 wherein the funds source is one of a cash account or a credit account.

7. The system of claim 1 wherein services provided over the network are singular to a provider or an aggregate combination of services by multiple providers over an SSN implementation.

8. The system of claim 1 wherein elements of security necessary to effect and support a transaction or activity on the network from the transceiver are provided at a base level as a function of the network.

9. The system of claim 8 wherein the base level elements of security on the network include at least one of mutual authentication, authorization, payload encryption, transport independent encryption, privacy, end to end audit, and non-repudiation for compliance reporting.

10. A system of claim 1 wherein the payload for a transaction is encrypted independent of the transport and the payment is specific to the participants of the transaction and the data stored is encrypted at rest and accessed only by one or more of participants to the transaction.

11. A system of claim 1 wherein a transaction UID that is unique to each transaction effected by the network is created and managed as a function of the network.

12. A system of claim 1 wherein: (a) a correlation UID that is specific to a series of service events on the network establishes transitive trust as a function of the network; (b) and the ability to track and recreate the events of a muti-service transaction are captured and maintained in a file specific to the transaction to allow the reconstruction of the events associated with a transaction

13. The system of claim 12 including end to end non-repudiation of a transaction.

14. A system of claim 1 wherein an origination UID that can be populated by the transceiver, user, or application connected to the SSN such that end to end logging and transitive authentication can be supported, tracked and enforced is created and managed as a function of the network.

15. A system of claim 1 where additional elements of security comprising at least one of WS-S, SAML, XML certificates, OLDAP, Active Directory, LDAP, and other credential related means in support of either further authorization or further authentication on the network for a given service or function are created and managed as a function of the network.

16. A system of claim 1 wherein the secure multifunction service network is provided as a web service.

17. A system of claim 16 wherein a web application is the service used through the transceiver.

18. A system of claim 1 wherein the service definition on the network includes linkages between web services from one or more providers and applications from one or more providers on an implementation of the SSN to effect an aggregated service on the network.
